(19) United States
(12) Patent Application Publication
(10) Pub. No.: US 2024/0426056 A1
(43) Pub. Date: Dec. 26, 2024

(54) SHEETS AND PROCESSES FOR DE-WETTING MEDIA

(71) Applicant: Georgia Tech Research Corporation, Atlanta, GA (US)

(72) Inventors: Sumner Dudick, Atlanta, GA (US); Victor Breedveld, Atlanta, GA (US); Dennis W. Hess, Atlanta, GA (US)

(21) Appl. No.: 18/703,071

(22) PCT Filed: Oct. 21, 2022
(86) PCT No.: PCT/US2022/078532

§ 371 Date: Apr. 19, 2024

Related U.S. Application Data
(60) Provisional application No. 63/270,627, filed on Oct. 22, 2021.

(51) Int. Cl. D21F 7/12; B32B 5/02; B32B 5/26; B32B 15/02; B32B 15/18; B32B 27/12; D21F 3/02; D21F 7/08

(52) U.S. Cl. CPC D21F 7/12; B32B 5/02; B32B 5/26; B32B 15/02; B32B 15/18; B32B 27/12; D21F 3/029; D21F 7/083; B32B 2307/73; B32B 2307/7376

(57) ABSTRACT

Disclosed herein are a de-wetting sheets comprising a base layer having a plurality of pores. The de-wetting sheet can have a compressed state in which liquid is allowed to flow through the plurality of pores and a decompressed state in which liquid is prevented from flowing through the plurality of pores. Also disclosed herein are methods of using the same comprising compressing a de-wetting sheet layer between a wetted fibrous layer and a felt layer in which a thickness and/or a stiffness of the de-wetting sheet layer is sufficient to preserve a void volume between the wetted fibrous layer and dry felt layer. The method can further comprise decompressing the de-wetting sheet layer, the wetted fibrous layer, and the felt layer.

### CROSS-REFERENCE TO RELATED APPLICATIONS

This application claims the benefit of U.S. Provisional Application Ser. No. 63/270,627, filed on 22 Oct. 2021, the entire contents and substance of which are incorporated herein by reference in their entirety as if fully set forth below.

### FIELD OF THE DISCLOSURE

The present disclosure relates generally to de-wetting processes and sheets. Particularly, embodiments of the present disclosure relate to de-wetting sheets for the dewatering of fibrous, especially paper, media.

### BACKGROUND

In 2021, the world consumed over 620 EJ of energy. Approximately 2.6 EJ, or about 0.4% of that total energy demand, was just used to dry paper during its manufacture. In a climate of growing energy costs and increasingly limited energy supplies, finding ways of improving the efficiency of this process are desperately needed. Even in state-of-the art paper mills, the energy used to dry paper is well over twice as much as is theoretically needed. Clearly, there is a massive opportunity to make a major impact on global energy consumption.

One problem plaguing papermakers is that, after water is squeezed out of the paper sheet, the sheet resorbs water from the fabric that carried it through the press. Essentially, when pressure is released, the paper sucks water back out of the sink (the fabric) that was provided to remove it. No technology has yet been developed that can entirely avoid this rewetting tendency. Therefore, a fabric with one-way flow properties is desirable in the industry for decades. Creating a fabric that lets water in, but doesn't let it out, would drastically reduce the amount of water that has to be dried from the sheet later. Arriving at any such solution would require implementing technologies from the fields of flow in porous media, surface chemistry and wettability, partitioning of liquid droplets, and the physics of interfacial instability.

What is needed, therefore, are de-wetting materials that possess properties to remove fluid from a sheet without allowing fluid to re-wet the sheet during the de-wetting process. Embodiments of the present disclosure address this need as well as other needs that will become apparent upon reading the description below in conjunction with the drawings.

### BRIEF SUMMARY OF THE DISCLOSURE

The present disclosure relates generally to de-wetting processes and sheets. Particularly, embodiments of the present disclosure relate to de-wetting sheets for the dewatering of paper media.

An exemplary embodiment of the present disclosure can provide a process for de-wetting, the process comprising: compressing a de-wetting sheet layer between a wetted fibrous layer and a felt layer, the de-wetting sheet layer comprising a plurality of pores, and the de-wetting sheet layer having a compressed state in which (i) liquid is allowed to flow therethrough and (ii) in which a thickness and/or a stiffness of the de-wetting sheet layer is sufficient to preserve a void volume between the wetted fibrous layer and the felt layer; and decompressing the de-wetting sheet layer, the wetted fibrous layer, and the felt layer, the de-wetting sheet layer having a decompressed state in which liquid is prevented from flowing therethrough, wherein the liquid is transferred from the wetted fibrous layer to the felt layer through the de-wetting sheet layer when the de-wetting sheet layer is in the compressed state.

In any of the embodiments disclosed herein, in the decompressed state, liquid can be prevented from flowing through the de-wetting sheet layer by severing a liquid film in the de-wetting sheet layer.

In any of the embodiments disclosed herein, the wetted paper layer and the felt layer can comprise hydrophilic material and the de-wetting sheet layer can comprise hydrophobic material.

In any of the embodiments disclosed herein, the de-wetting sheet layer can comprise a polymer.

In any of the embodiments disclosed herein, the de-wetting sheet layer can comprise a surface layer having a functional surface modification.

In any of the embodiments disclosed herein, the compression step can maintain the de-wetting sheet layer in the compressed state for a time period from approximately 1 millisecond to approximately 15 seconds.

In any of the embodiments disclosed herein, the thickness of the de-wetting sheet layer can be sufficient to prevent rewetting of liquid transferring from the felt layer to the wetted paper layer when the de-wetting sheet layer is in the decompressed state.

In any of the embodiments disclosed herein, the de-wetting sheet layer can have a thickness from approximately 50 μm to approximately 500 μm.

In any of the embodiments disclosed herein, the plurality of pores each can have a pore size from approximately 50 μm to approximately 500 μ.

In any of the embodiments disclosed herein, the plurality of pores can have a total volume that decreases by 10% or less when the de-wetting sheet layer is compressed at a pressure of approximately 10 MPa or less.

In any of the embodiments disclosed herein, the total volume of the plurality of pores can decrease by 50% or less when the de-wetting sheet layer is compressed at a pressure of approximately 10 MPa or less.

In any of the embodiments disclosed herein, the total volume of the plurality of pores can decrease by 75% or less when the de-wetting sheet layer is compressed at a pressure of approximately 10 MPa or less.

In any of the embodiments disclosed herein, the plurality of pores can have a first total volume in the compressed state and a second total volume in the decompressed state, the first total volume and the second total volume being approximately equivalent.

In any of the embodiments disclosed herein, the plurality of pores can have a third total volume when compressed at a pressure of approximately 10 MPa, the third total volume being approximately equal to the first total volume and the second total volume.

Another embodiment of the present disclosure can provide a de-wetting sheet comprising: a base layer comprising a plurality of pores; wherein the de-wetting sheet has (i) a compressed state in which liquid is allowed to flow through the plurality of pores and the base layer has a thickness and/or a stiffness sufficient to preserve a void volume of the plurality of pores, and (ii) a decompressed state in which liquid is prevented from flowing through the plurality of pores.

In any of the embodiments disclosed herein, in the decompressed state, liquid can be prevented from flowing through the de-wetting sheet layer by severing a liquid film in the de-wetting sheet layer.

In any of the embodiments disclosed herein, the de-wetting sheet layer can comprise a hydrophobic material.

In any of the embodiments disclosed herein, the base layer can comprise a polymer.

In any of the embodiments disclosed herein, the de-wetting sheet can further comprise a surface layer having a functional surface modification.

In any of the embodiments disclosed herein, the de-wetting sheet layer can be maintained in in the compressed state for a time period from approximately 1 millisecond to approximately 15 seconds.

In any of the embodiments disclosed herein, the de-wetting sheet can be positioned between a felt layer and a wetted fibrous layer.

In any of the embodiments disclosed herein, the thickness of the de-wetting sheet layer can be sufficient to prevent rewetting of liquid transferring from the felt layer to the wetted fibrous layer when the de-wetting sheet layer is in the decompressed state.

In any of the embodiments disclosed herein, the de-wetting sheet layer can have a thickness from approximately 50 μm to approximately 500 μm.

In any of the embodiments disclosed herein, the plurality of pores each can have a pore size from approximately 50 μm to approximately 500 μ.

In any of the embodiments disclosed herein, the plurality of pores can have a total volume that decreases by 10% or less when the de-wetting sheet layer is compressed at a pressure of approximately 10 MPa or less.

In any of the embodiments disclosed herein, the total volume of the plurality of pores can decrease by 50% or less when the de-wetting sheet layer is compressed at a pressure of approximately 10 MPa or less.

In any of the embodiments disclosed herein, the total volume of the plurality of pores can decrease by 75% or less when the de-wetting sheet layer is compressed at a pressure of approximately 10 MPa or less.

In any of the embodiments disclosed herein, the plurality of pores can have a first total volume in the compressed state and a second total volume in the decompressed state, the first total volume and the second total volume being approximately equivalent.

In any of the embodiments disclosed herein, the plurality of pores can have a third total volume when compressed at a pressure of approximately 10 MPa, the third total volume being approximately equal to the first total volume and the second total volume.

Another embodiment of the present disclosure can provide a de-wetting sheet comprising: a felt layer; and a base layer disposed on the felt layer, the base layer comprising a plurality of pores; wherein the de-wetting sheet has (i) a compressed state in which liquid is allowed to flow through the plurality of pores and the base layer has a thickness and/or a stiffness sufficient to preserve a void volume of the plurality of pores, and (ii) a decompressed state in which liquid is prevented from flowing through the plurality of pores.

In any of the embodiments disclosed herein, in the decompressed state, liquid can be prevented from flowing through the base layer by severing a liquid film in the de-wetting sheet layer.

In any of the embodiments disclosed herein, the base layer can comprise a hydrophobic material.

In any of the embodiments disclosed herein, the base layer can comprise a polymer.

In any of the embodiments disclosed herein, the de-wetting sheet can further comprise a surface layer disposed on the base layer, the surface layer having a functional surface modification.

In any of the embodiments disclosed herein, the de-wetting sheet layer can be maintained in in the compressed state for a time period from approximately 1 millisecond to approximately 15 seconds.

In any of the embodiments disclosed herein, the de-wetting sheet can be contacted with a wetted fibrous layer.

In any of the embodiments disclosed herein, the thickness of the de-wetting sheet layer can be sufficient to prevent rewetting of liquid transferring from the felt layer to the wetted fibrous layer when the de-wetting sheet layer is in the decompressed state.

In any of the embodiments disclosed herein, the de-wetting sheet layer can have a thickness from approximately 50 μm to approximately 500 μm.

In any of the embodiments disclosed herein, the plurality of pores each can have a pore size from approximately 50 μm to approximately 500 μ.

In any of the embodiments disclosed herein, the plurality of pores can have a total volume that decreases by 10% or less when the de-wetting sheet layer is compressed at a pressure of approximately 10 MPa or less.

In any of the embodiments disclosed herein, the total volume of the plurality of pores can decrease by 50% or less when the de-wetting sheet layer is compressed at a pressure of approximately 10 MPa or less.

In any of the embodiments disclosed herein, the total volume of the plurality of pores can decrease by 75% or less when the de-wetting sheet layer is compressed at a pressure of approximately 10 MPa or less.

In any of the embodiments disclosed herein, the plurality of pores can have a first total volume in the compressed state and a second total volume in the decompressed state, the first total volume and the second total volume being approximately equivalent.

In any of the embodiments disclosed herein, the plurality of pores can have a third total volume when compressed at a pressure of approximately 10 MPa, the third total volume being approximately equal to the first total volume and the second total volume.

These and other aspects of the present disclosure are described in the Detailed Description below and the accompanying figures. Other aspects and features of embodiments of the present disclosure will become apparent to those of ordinary skill in the art upon reviewing the following description of specific, exemplary embodiments of the present invention in concert with the figures. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments of the invention discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The accompanying drawings, which are incorporated in and constitute a part of this specification, illustrate multiple embodiments of the presently disclosed subject matter and serve to explain the principles of the presently disclosed subject matter. The drawings are not intended to limit the scope of the presently disclosed subject matter in any manner.

FIG. 1 illustrates a schematic of a de-wetting process of a wetted fibrous sheet by pressing against felt according to some examples found in the prior art.

FIG. 2 is a schematic of a de-wetting process with de-wetting sheet, in accordance with the present disclosure.

FIG. 3 illustrates a flowchart of a de-wetting process, in accordance with the present disclosure.

FIGS. 4A and 4B are optical microscope images of example de-wetting sheets, in accordance with the present disclosure.

FIG. 5 is a plot of moisture content after compression for examples of de-wetting sheets, in accordance with the present disclosure.

FIGS. 6A and 6B are plots of moisture ratio as a function of applied pressure for examples of de-wetting sheets, in accordance with the present disclosure.

FIG. 7 is another plot of moisture ratio for examples of de-wetting sheets with different surface functionalization, in accordance with the present disclosure.

FIG. 8 is another plot of moisture ratio for examples of de-wetting sheets with various liquids, in accordance with the present disclosure.

FIG. 9 is a plot of pressed solids versus applied pressure for examples of de-wetting sheets, in accordance with the present disclosure.

FIG. 10 is a plot of pressed solids versus pore size for examples of de-wetting sheets, in accordance with the present disclosure.

FIG. 11 is a plot of pressed solids versus applied pressure for additional examples of de-wetting sheets, in accordance with the present disclosure.

FIG. 12 is a plot of pressed solids for additional examples of de-wetting sheets, in accordance with the present disclosure.

### DETAILED DESCRIPTION

The invention described herein reduces the need for energy-intensive drying. By creating a fabric with enhanced dewatering capability, more water can be squeezed from the paper sheet mechanically. Thus, there can be a significant about 40-50% reduction in the amount of water that has to be evaporated in the dryer section, cutting the energy requirements of drying paper by an approximately equivalent amount.

Wherever needed, the following symbols and abbreviations are referred to throughout this disclosure.
a Radius of droplet's contact line on surface
Bo Bond number
Ca Capillary number
d Fiber spacing
d_{eff} Effective pore size
dₙₒₘᵢₙₐₗ Nominal pore size
dₚ Pore size
F Adhesive force
h Height of droplet on surface
H Vertical distance between surfaces
Hₘᵢₙ Minimum vertical distance between surfaces
K Nondimensional curvature
L Length scale
M_{fiber} Mass of fiber in the sheet
m_{water} Mass of water in the sheet
n Vector normal to liquid-air interface
P Pressure
P_{critical} Critical wetting pressure
rₚ Pore radius
t Time
t_{I} Inertial breakup timescale
tᵥ Viscous breakup timescale
v Velocity
\hat{v} Nondimensional velocity
V Droplet volume
We Weber number
∇P Pressure gradient
ΔP Difference in pressure across interface
θ Contact angle
θₐ Advancing contact angle
θᵣ Receding contact angle
κ Permeability
μ Viscosity
σ Surface tension
ACA Advancing contact angle
CA Contact angle
CAH Contact angle hysteresis
EG Ethylene glycol
MR Moisture ratio
PFE Pentafluoroethane
RCA Receding contact angle
RF Radio frequency
SBSK Southern bleached softwood Kraft
SCA Static contact angle
SDS Sodium dodecyl sulfate
SEM Scanning electron microscope
TR Transfer ratio
W Water
W/EG Water and ethylene glycol solution

By creating a wetting gradient in the fabric, it is theoretically possible to allow water into the structure at high pressures but prevent it from leaving at low pressures (i.e., during decompression). To accomplish this, the physics of forced wetting in fibrous materials (e.g., non-woven fabrics, paper) was studied in detail. The inventors found that existing models for these wetting barriers in fibrous media were inaccurate and therefore inappropriate for informing design choices. One outcome of such work can be a method for accurately predicting the wetting resistance of hydrophobic fiber networks.

By making water more strongly adhere to the fabric, less water goes with the paper sheet when it is pulled away from the wet fabric. The present disclosure demonstrates that altering adhesion can be used to control the transfer of water from two separating surfaces.

The present disclosure includes creating a fabric with improved dewatering ability which can lead to a radical change of perspective on the problem of rewet. This can involve inducing an interfacial instability in the liquid lying between the paper sheet and the press fabric. The details of encouraging this instability and its effect on dewatering are explored below. Essentially, rupturing the liquid bridging the fabric and paper destroys all paths for flow. If this process is carefully implemented, full dewatering of the paper under pressure can occur, without any water returning to the sheet upon decompression.

This invention improves many aspects of wetting and flow in fibrous materials. One aim of the present disclosure is to provide fabrics for improved dewatering.

Although certain embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. Other embodiments of the disclosure are capable of being practiced or carried out in various ways. Also, in describing the embodiments, specific terminology will be resorted to for the sake of clarity. It is intended that each term contemplates its broadest meaning as understood by those skilled in the art and includes all technical equivalents which operate in a similar manner to accomplish a similar purpose.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified.

The components described hereinafter as making up various elements of the disclosure are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter.

Paper is made by suspending cellulose fibers in water at a ratio of about 200 parts water to fiber (0.5 wt. % solids) and then removing that water to create a consolidated web, also called the sheet, that contains 90-95 wt. % solids at the end of the process. Three serial sections of the paper machine are used to achieve this: forming, pressing, and drying.

First, the vast majority of water is removed by gravity-driven drainage in the forming section. During this stage, the dilute fiber suspension (stock) is pumped from a pressurized dispenser (the headbox) onto a forming fabric. The forming fabric is a woven cloth that serves as a filter-collecting the fibers into a mat while allowing water to pass through. The reason so much water has to be used in forming the sheet is that a dilute suspension prevents fiber aggregation, resulting in paper that is smoother and stronger. Although gravity is the primary force accomplishing water removal in the forming section, shear forces induced by hydrofoils and vacuums are used at the end of the forming section to further reduce the water content. At the end of forming, the paper sheet has taken shape, and its relative water content has reduced from a 200:1 slurry to a 3:1 pulpy mat.

Second, the press section applies mechanical work to squeeze more water from the paper web. This process may also be referred to as mechanical dewatering or wet pressing. In pressing, the paper sheet is supported by a fabric, known as the press felt, that carries the damp sheet when it is too soft to be pulled by the machine, that provides a sink for the water during pressing, and that imparts a desired surface finish to the sheet. The press felt and paper web are fed into a tight gap (nip), where force applied on the press roll expels water from the sheet, much like dewatering a shirt with an old-fashioned clothes wringer. Nip configuration has a major impact on press section efficiency, with styles varying from the more conventional rolling nip (created by the gap between two rolling cylinders) to the current state of the art-extended nip presses. The nip is extended by complementing the cylindrical press roll with a concave shoe; this provides a crucial innovation in dewatering by increasing the dwell time over which pressure is applied. Within an extended nip press, the ratio of water in the sheet can decrease to about 0.6:1 or even 0.5:1 for some pulp furnishes. However, the relative water content of the sheet after leaving the press nip increases to about 1:1. This is because the sheet exiting the press typically reabsorbs water from the press fabric (rewet). This reabsorbed water must then be removed in the subsequent section-drying.

Finally, the sheet is heated to evaporatively dry the residual water remaining after pressing. The paper is contacted with steam-heated drums, which require a large amount of energy to run because of water's high latent heat. After drying, the relative mass of water in the sheet compared to fiber is about 0.05:1. Because drying is about ten times more energy intense compared to pressing, papermakers have long looked for ways to improve mechanical dewatering in the press section by eliminating rewet. Improving the press section in such a way as to prevent rewet could reduce the energy demand of drying by about 40-50%. Working to mitigate or even eliminate rewet, however, requires an understanding of the phenomena that cause this undesired reflux of water.

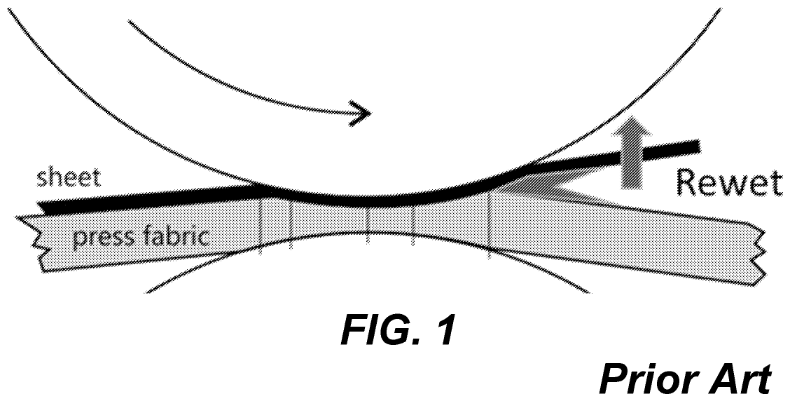

Rewet—the main problem limiting papermakers' ability to further decrease the moisture content of the sheet after pressing—has been a known problem since the 1960's. For over half a century, scientists have realized that the paper web tends to resorb water from the press felt after exiting the press section. In that time period, pressing technology advanced a considerable degree. Enhanced dewatering was obtained by use of extended nips, heated presses, and better press felt materials/designs. The chief accomplishment of these innovations is that modern press nips can achieve moisture content in the paper remarkably close to the thermodynamic equilibrium while pressure is applied. However, as soon as the web-felt system undergoes decompression, water reflux from the press fabric to the paper undoes much of the progress made in water removal. An example of such a process is shown in FIG. 1.

The driving force for this undesired transport is caused by two key properties of paper: its elasticity and hydrophilicity. When pressure is released, the paper web recovers some, but not all, of its original bulk. This expansion opens pores within the fiber matrix, which are highly hydrophilic due to the chemistry of cellulose. Thus, the pores exert strong capillary forces on the water, drawing it back into the paper. This phenomenon-desaturation providing a driving force for undesired reflux—is referred to as flow rewet. Because flow rewet is a time-dependent phenomenon according to the Lucas-Washburn equation (Equation 1), papermakers have been able to reduce the extent to which flow rewet occurs by rapidly separating the paper from the felt after pressing.

$$L = \sqrt{\frac{σ {r}_{p} t cos θ}{2 μ}} \qquad ( 1 )$$

L is the depth to which liquid penetrates into the medium, rₚ the pore radius of the medium, t the exposure time of the porous medium to the liquid, θ the contact angle of liquid of the surface, and u the liquid's viscosity. Reducing the time of contact thus decreases the extent to which reflux can occur.

In addition to flow rewet, there is another phenomenon which gives rise to undesired transport-separation rewet. Because both the paper and felt are rough surfaces, the interface between them is filled with spaces and voids. Water that collects in these interstitial cavities between the two surfaces must then attach to one surface or the other when the two are pulled apart. Once again, the strong hydrophilicity of the paper web results in more of this interstitial water getting pulled with the paper, rather than remaining with the felt.

Furthermore, the present disclosure can prevent flow rewet by trapping water in the felt with a wetting barrier. This would prevent the paper sheet from resorbing water after the press. Because the effectiveness of this technique is pressure-dependent, precise knowledge of how this pressure dependence relates to the fundamental parameters of the system is essential. The inventors have developed a quantitatively predictive method for the strength of this wetting barrier—no one else has yet produced an accurate model-based only on fundamental parameters, without fit factors—for wetting barriers in phobic fiber networks.

The present disclosure also can aid the possibility of reducing separation rewet by controlling the adhesion of a droplet to the fiber network. To accomplish this, liquid is squeezed between two surfaces before the surfaces are pulled apart. By observing what fraction of the liquid adheres to each surface, conclusions are reached about the effectiveness of strategies to control the fate of water when the press felt is pulled away from the paper.

The present disclosure also includes a new approach to creating a fabric with one-way flow properties. Destabilization of water bridges lying between the felt and paper results in the breakup of channels necessary for backflow to the sheet during rewet. Appreciating the mechanism of this revolutionary dewatering concept requires an understanding of the physics of interfacial instability.

The present disclosure can take that broader background into more specific insights that can be used to control transfer of liquids in a press section. The present disclosure can take into account what can be done with the intrinsic features of fibrous materials alone because these insights would be most informative for guiding press fabric design. Furthermore, the lack of data in the existing literature on liquid transfer specifically between fibrous media justifies homing in on that class of materials. Therefore, the experimental approach described herein can be tailored to show the immense degree of control available over liquid droplets partitioning between separating surfaces, using tools intrinsic to fiber networks. Whether by leveraging the geometry of the fibers themselves, the fibrillar nanostructure of cellulose, inertial and viscous forces inherent to the liquid, or any combination of these, a surprising degree of control over the transfer of liquids between separating fiber networks can be reached.

Because paper is more compressible than the press fabric, its void volume becomes completely collapsed under the pressures applied in the nip. After all, this is how removal of the sheet's free water is accomplished in the first place. That means that under pressure, the paper substrate can be treated as a surface with an impermeable boundary. To encourage transport away from this surface, the opposing material, a press felt, should retain an open pore structure to absorb water. The only remaining challenge is to suspend the felt at a distance from the paper-all under nip pressure-so that a gap is created for the liquid channels to break at the end of transfer. Fortunately, these goals can be accomplished mechanically. Insertion of a stiff spacer between the felt and web preserves void space under pressure, allowing air to enter the interface after the liquid bridges break. Now, when the system undergoes decompression, the sheet has already been completely dewatered and there is no path for reflux to the sheet.

While other methods have previously been developed to promote unidirectional flow, this approach provides a solution where those existing techniques fail to be practical, such as in a paper machine press section. The inventors are the first to develop, discuss, and optimize the Plateau-Rayleigh interfacial instability to enhance dewatering of porous media. Key advantages of leveraging the Plateau-Rayleigh instability to prevent reflux include: a passive design with no moving parts, a highly permeable structure that does not restrict flow, and a short timescale of operation amenable to rapid industrial processes.

The inventors also investigated the effect of the spacer's structural parameters on enhanced dewatering, as well as the impact of surface wettability. One major insight is that this technology results in enhanced dewatering for liquids with a wide range of surface tensions and viscosities. In addition to numerous data exploring the effects of surface wettability and liquid properties on enhanced dewatering, analysis of videos of the dewatering process supplement and inform discussion of the fundamental aspects of fluid physics at play.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

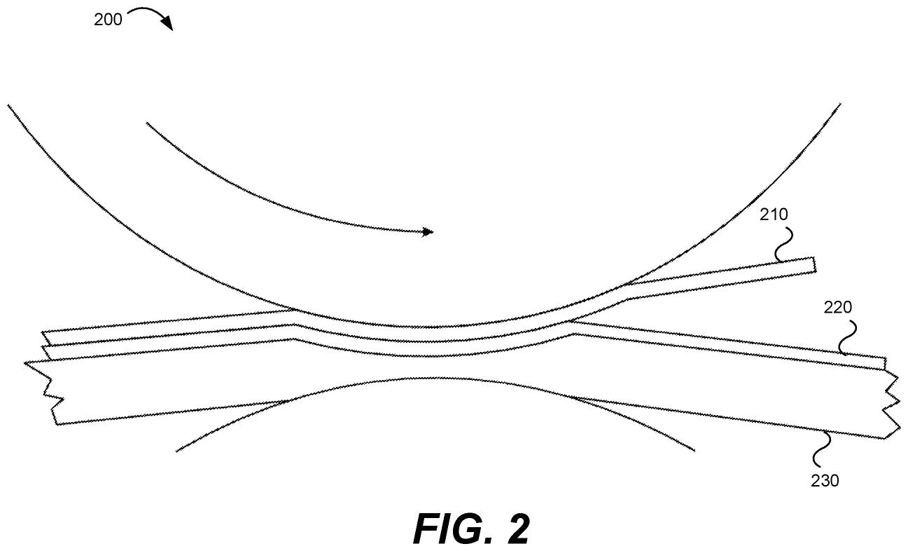

FIG. 2 illustrates an example de-wetting apparatus 200. As shown, the de-wetting apparatus can comprise a de-wetting sheet 220 disposed between a wetted fibrous layer 210 and a felt layer 230. As shown, the de-wetting apparatus 200 can compress the de-wetting sheet 220 between the wetted fibrous layer 210 and the felt layer 230. The de-wetting sheet 220 can comprise a plurality of pores. The plurality of pores can each have a pore size and a void volume. The de-wetting sheet 220 can be made from a hydrophobic material. Furthermore, the de-wetting sheet 220 can comprise a polymer. Alternatively, or in addition, the de-wetting sheet 220 can comprise a surface layer on a surface contacting the felt layer 230 and/or a surface contacting the wetted fibrous layer 210. The surface layer can have a functional surface modification thereon.

The de-wetting sheet 220 can be a separate layer from the felt layer 230. Alternatively, the de-wetting sheet 220 can be disposed on the felt layer 230. In such a manner, the de-wetting sheet 220 can be integrated with the felt layer 230. The de-wetting sheet 220 can further be a separate layer that is attached to the felt layer 230 by a variety of attachment mechanisms known to those of ordinary skill in the art. That is to say, the de-wetting sheet 220 can be detachably attached to the felt layer 230.

The de-wetting sheet 220 can have a thickness from approximately 50 μm to approximately 500 μm (e.g., from 60 μm to 490 μm, from 70 μm to 480 μm, from 80 μm to 470 μm, from 90 μm to 460 μm, from 100 μm to 450 μm, from 110 μm to 440 μm, from 120 μm to 430 μm, from 130 μm to 420 μm, from 140 μm to 410 μm, from 150 μm to 400 μm, from 160 μm to 390 μm, from 170 μm to 380 μm, from 180 μm to 370 μm, from 190 μm to 260 μm, or from 200 μm to 250 μm). Alternatively, or in addition, the thickness of the de-wetting sheet 220 can be approximately equivalent to the pore size.

Furthermore, the de-wetting sheet 220 can have a sufficient thickness to prevent rewetting of liquid transferring from the felt layer 230 to the wetted fibrous layer 210 when the de-wetting sheet 220 is in the decompressed state.

The plurality of pores each can have a pore size from 50 μm to approximately 500 μm (e.g., from 60 μm to 490 μm, from 70 μm to 480 μm, from 80 μm to 470 μm, from 90 μm to 460 μm, from 100 μm to 450 μm, from 110 μm to 440 μm, from 120 μm to 430 μm, from 130 μm to 420 μm, from 140 μm to 410 μm, from 150 μm to 400 μm, from 160 μm to 390 μm, from 170 μm to 380 μm, from 180 μm to 370 μm, from 190 μm to 260 μm, or from 200 μm to 250 μm). Alternatively, or in addition, pore size can be approximately equivalent to the thickness of the de-wetting sheet 220.

Further, the plurality of pores can each have a total volume (e.g., the summed volume of all pores) that, when compressed at a pressure of approximately 10 MPa or less, decreases by an amount of 75% or less (e.g., 70% or less, 65% or less, 60% or less, 55% or less, 50% or less, 45% or less, 40% or less, 35% or less, 30% or less, 25% or less, 20% or less, 15% or less, or 10% or less). In such a manner, the de-wetting sheet 220 can have a sufficient stiffness to preserve the void volume of the plurality of pores.

The plurality of pores can have a void volume (e.g., an open area percentage) from approximately 20% to approximately 60% (e.g., from 25% to 55%, from 30% to 50%, from 35% to 45%, from 25% to 60%, from 30% to 60%, from 35% to 60%, from 40% to 60%, from 45% to 60%, or from 50% to 60%).

The de-wetting sheet 220 can also have a compressed state and a decompressed state. The de-wetting sheet 220 can allow liquid to flow therethrough in the compressed state. Furthermore, the de-wetting sheet 220 can have sufficient material properties as described above to preserve the void volume between the wetted fibrous layer 210 and the felt layer 230. In the decompressed state, the de-wetting sheet 220 can prevent liquid from flowing therethrough. Without wishing to be bound by any particular scientific theory, such a phenomenon can be due to the de-wetting sheet 220 severing a liquid film within the de-wetting sheet 220.

Alternatively, or in addition, liquid passing through the de-wetting sheet 220 can be reduced in the decompressed state relative to the compressed state. Liquid need not be completely and entirely prevented from flowing through the de-wetting sheet 220 when in the decompressed state. It will be understood that liquid flowing through the de-wetting sheet 220 can be significantly reduced when in the decompressed state such that the rewet of the wetted fibrous layer 210 is reduced. Accordingly, an amount of liquid flowing through the de-wetting sheet 220 in the decompressed state can be reduced relative to the amount of liquid flowing through the de-wetting sheet 220 in the compressed state by an amount 10% or greater (e.g., 15% or greater, 20% or greater, 25% or greater, 30% or greater, 35% or greater, 40% or greater, 45% or greater, 50% or greater, 55% or greater, 60% or greater, 65% or greater, 70% or greater, 75% or greater, 80% or greater, 85% or greater, 90% or greater, or 95% or greater). As will be appreciated, a reduction by an amount of 100% can mean that liquid is prevented from flowing therethrough.

Alternatively, or in addition, the plurality of pores each can have a first total volume in the compressed state and a second total volume in the decompressed state. The first total volume and the second total volume can be approximately equivalent. The first total volume and the second total volume may be equal. The second total volume may represent an insubstantial decrease when compared to the first total volume. In other words, the total volume of the plurality of pores does not undergo a significant change when in the compressed state when compared to the total volume of the plurality of pores in the decompressed state. In such a manner, the de-wetting sheet 220 can have a sufficient stiffness to preserve the void volume of the plurality of pores.

Furthermore, the plurality of pores each can have a third total volume when compressed at a pressure of approximately 10 MPa or less. The third total volume can be approximately equivalent to the first total volume and/or the second total volume. The third total volume may be equal to the first total volume and/or the second total volume. The third total volume may represent an insubstantial decrease when compared to the first total volume and/or the second total volume. In other words, the total volume of the plurality of pores does not undergo a significant change when compressed at a pressure of approximately 10 MPa or less. In such a manner, the de-wetting sheet 220 can have a sufficient stiffness to preserve the void volume of the plurality of pores.

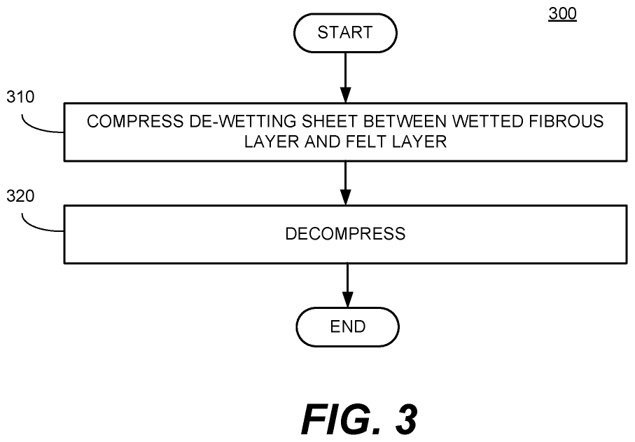

FIG. 3 illustrates a flowchart of a process 300 for de-wetting. As shown in block 310, the process can comprise compressing a de-wetting sheet layer 220 between a wetted fibrous layer 210 and a felt layer 230, as described above. Further, in block 320, the process can comprise decompressing the de-wetting sheet layer 220, the wetted fibrous layer 210, and the felt layer 230, as described above. The compressing 310 can place the de-wetting sheet layer 220 in the compressed state, and the decompressing 320 can place the de-wetting sheet layer 220 in the decompressed state.

The compression 310 can maintain the de-wetting sheet 220 in the compressed state for a time period from approximately 1 millisecond to approximately 15 seconds (e.g., from 10 milliseconds to 15 seconds, from 100 milliseconds to 15 seconds, from 1 second to 15 seconds, from 5 seconds to 15 seconds, from 10 seconds to 15 seconds, from 1 millisecond to 100 milliseconds, or from 1 millisecond to 10 milliseconds).

As previously discussed, the performance of the spacer is highly dependent on its geometry. The investigation conducted so far was limited in this respect by utilizing commercially available metal (and nylon) meshes. Although their convenience made them indispensable for the first phase of developing this technology, an attempt to design the spacer from the ground up should be made in the future. Doing so would overcome the limitations of using ready-made meshes. For example, one cannot independently vary the pore size, wire diameter, and mesh thickness to a great extent in commercially available meshes. This unnecessarily reduces design choices. Another drawback is that the curvature of the wires in the mesh—while essential to inducing interfacial instability—also likely trap some water between the spacer and paper surface. Designing a custom spacer could overcome this problem by having a smooth spacer surface meet the paper and pore walls with the appropriate interior curvature.

Fluid simulations might help discover what curvature for the pore walls is ideal. There are immense caveats, of course, to simulating multiphase breakup of fluid on the microscale. However, such a tool may be useful in quickly scanning potential spacer designs, to facilitate fabrication and testing. Because materials with known parameters have already been tested, it should be straightforward to assess the validity of such simulations. For breaking water channels, more slender openings relative to gap thickness would be preferable; such simulations might be a convenient method for testing that hypothesis.

One important question remaining about the applicability of the spacer layer concept to industrial manufacturing is to what extent it will function under process conditions. An analysis of the physics that govern liquid bridge breakup suggest that the technology will be effective at process time scales. However, the only way to make certain is to actually test it. Doing so would require access to a pilot paper machine. Notably, the path to such tests is bottlenecked by the concerns above, as well as the possibility of multidimensional flow.

The present disclosure can take care to establish unidimensional pressure gradients in the transverse direction only. This was done to simplify the problems of flow and elucidate some of the fundamental aspects of enhanced dewatering, at least for initial investigations. In the press section of a paper machine, the curvature of the press roll can create pressure gradients in the machine direction as well. However, the extent to which this poses a real problem is somewhat unclear. Compared to lab-scale nips—with high roll curvature and, thus strong machine-direction pressure gradients-industrial presses have less curvature and are more likely to exhibit more one-dimensional pressure profiles.

The possible influence of machine-direction pressure gradients cannot be overlooked in spacer design, however. In such cases, spacers that create channels along the machine direction could result in compromised dewatering as the press pushes water forward into already-dewatered paper. Since the spacer technology works by maintaining voids at the paper-felt interface, this is a concern that must be recognized. Given appropriate attention to design, these potential problems can be confidently avoided.

The effect of the spacer on sheet properties is an essential question that must be thoroughly considered in future work on this project. First, the spacer can impart roughness to the sheet, which may or may not be desired, depending on the application. Understanding how the spacer's structure contributes to final sheet surface roughness, after additional processing steps like coating and calendaring is a question best investigated at the pilot scale. Second, the enhanced dewatering possible with a spacer means that similar sheet dryness can be achieved by applying less pressure. Doing so could result in a bulkier sheet, as it has undergone less consolidation in the press. Bulk is a highly sought-after sheet property for grades that benefit from bending stiffness, absorbency, softness (in the case of tissue), and all grades sold by area rather than weight. This adds another dimension to fabrics for improved dewatering and is a benefit that should serve as a major focus in future work with this technology.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

### EXAMPLES

The following examples are provided by way of illustration but not by way of limitation.

A 6-inch parallel plate plasma reactor was used to hydrophobize the samples by plasma assisted vapor deposition of a fluorocarbon film from a pentafluoroethane (PFE) precursor. Further details concerning the reactor configuration can be found in previously published papers. Flows of 75 sccm Argon and 20 sccm PFE were used to establish a reactor pressure of 1.4 Torr; depositions were performed at 110° C. An RF power of 100 W was applied to the upper electrode for 1 min to deposit and covalently bond a ˜100 nm fluorocarbon coating (as measured on a flat, non-porous silicon wafer) on each porous substrate.

Contact angles were measured on a 290 model ramé-hart goniometer by introducing 4 μL of probe liquid. The static contact angle was fitted by DROPimage, the analysis tool native to the instrument. Increasing droplet volume was used to determine advancing contact angle, while retracting droplet volume was used to determine the receding contact angle. The difference between these two, the contact angle hysteresis, characterizes the droplet adhesion to the surface.

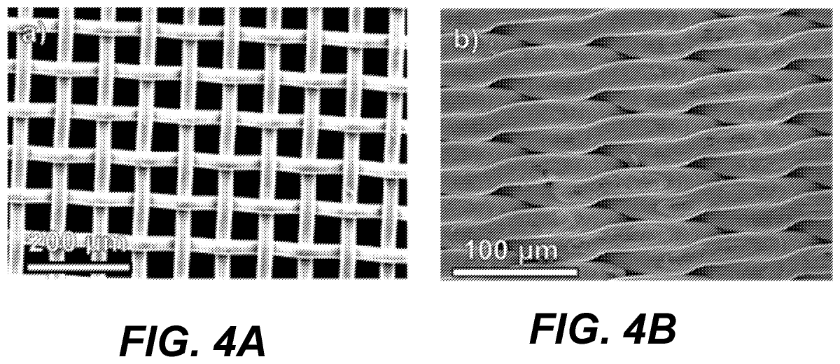

Metal meshes constitute a single layer of intercrossed filaments. They are highly uniform: both the wire diameter and wire spacing exhibit little variation, as seen in FIGS. 4A and 4B. Thus, stochastic effects can be ignored when interpreting the results of these experiments.

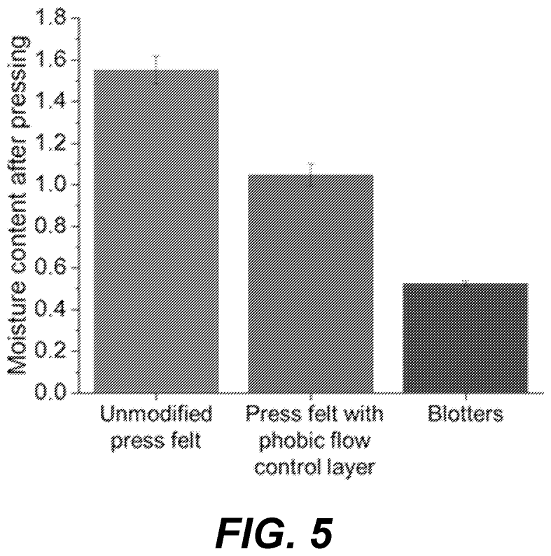

Three press felt designs were tested, with the results summarized in FIG. 5. First, a conventional press felt served as the control. This established a reference for dewatering compromised by rewet. Second, a press felt with a suitably strong wetting barrier was used. To create this felt, a fiber network with finer features than the chromatography paper would have to be created, hydrophobized, and attached to the surface of the felt. To implement this design in a proof-of-concept, lab-scale test, the inventors first hydrophobized a filter paper, which can exert twice as strong capillary forces as the chromatography paper, based on previous analysis. This phobic filter was then laid between the chromatography paper and press felt during pressing. The third press “felt” consists of a thick stack of paper blotters. The purpose of this configuration is to establish the theoretical limit of dewatering in the absence of rewet. Details about how the blotters work are described herein, including discussion of benchtop pressing at length. For now, it may be taken for granted that the blotters simulate a perfect press felt: one that permits no rewet.

FIG. 5 shows that a sheet pressed with a standard press fabric is significantly wetter than one pressed against blotters. This indicates that rewet can result in a sheet with more than twice as high a moisture content, at least when pressed on the lab-scale. Granted, the experimental conditions chosen tend to exaggerate the phenomenon of reflux, compared to what would likely be seen in an industrial application. This can be because the felt remains in contact with the paper web for a long time after decompression (order of seconds). However, conditions that pronounce this phenomenon are actually helpful because they allow for a clearer delineation of effects.

Introducing a hydrophobic control layer to the felt was successful in mitigating rewet. The moisture content of the sheet pressed with this felt design was significantly lower than that of the control press fabric. The moisture ratio of the dewatered sheet was about 1, compared to its initial value of 2. First, this demonstrates that dewatering is possible through the hydrophobic barrier at the relatively high pressures applied. 10 MPa of applied stress was sufficient to push water through the phobic filter, which had an estimated critical wetting pressure of only about 15 kPa. Second, the felt with the wetting gradient was able to decrease the amount of reflux to the sheet, compared to the control. Interestingly, the felt with an adequately large wetting barrier did not completely eliminate rewet, as can be seen by comparison to the blotters.

This revolves around the forced wetting of the hydrophobic barrier during dewatering. By forcing water into this hydrophobic fiber network at high pressures, cavities on the rough fiber surface may be partially wetted. This would result in a small amount of liquid remaining in some pockets of the phobic region during decompression. The existence of residual water in the network provides a path for reflux through the otherwise repellant wetting barrier. Essentially, the barrier might be short-circuited by the presence of these wetted channels.

As a final consideration, the porous nature of the paper web and the press fabric means that fluid can also flow into each of these separating substrates while they are being pulled apart. To fully understand the mechanics of separation rewet in a press section, it is necessary to simultaneously consider adhesive surface forces, inertial forces, and flux into each of the substrates.

Whatman cr17 chromatography paper was used as the wetted fibrous (e.g., paper) substrate in this study. Its chemical purity (98% cellulose of softwood origin) eliminates any complexities that would arise from chemical heterogeneity. Furthermore, its thickness (0.9 mm), elasticity (1 GPa, wet), and pore size (75 μm) exacerbated the reflux phenomenon. An elastic, highly hydrophilic paper sample with larger pore volume-compared to other papers tends to increase the quantity of water that can return to the web. This was helpful in exploring the effect of spacer and fluid properties on mitigating reflux, as their effects were more pronounced.

Prior to pressing, the initially dry half square inch sheet was wetted to a moisture ratio of 2 (67 wt. % water and 33 wt. % solids). The sheet was then pressed with varying felt configurations at a given pressure for 30 seconds. A screw press was used to apply a one-dimensional pressure gradient, and a TE Connectivity FC23 500 lb. piezo load cell enabled accurate control of applied stress. After pressing, the mass of the pressed sheet was compared to that of the dry sheet to determine its moisture content. Moisture content is reported in terms of the moisture ratio.

The press felt used in the study was obtained from a commercial supplier, AstenJohnson. The felt consists of a non-woven nylon batt-thin randomly oriented fibers used as the surface layer-spun from 3 dtex cap fibers stitched onto a woven base. The stainless steel meshes used as spacers were obtained from McMaster-Carr. Metal meshes of standard mesh numbers were used: 20, 30, 70, 200, and 400. Additionally, a 150W mesh (nonstandard version of 150 mesh with wider holes) with higher than standard open area was tested as a counter—example to liquid bridge instability. In some examples, the open area percentage can be similar to a void volume for the total plurality of pores. The mesh parameters are further summarized in Table 1.

TABLE 1
Static contact angle of water on example de-wetting
sheets with physical dimensions.

| | Static water | Wire | Hole | Radial/ | |
|---|---|---|---|---|---|
| | contact | diameter | width | axial | Open |
| Mesh # | angle (°) | (μm) | (μm) | curvature | area |
| 20 | wets | 427 | 849 | 1.0 | 44% |
| 30 | 63.8 | 325 | 516 | 1.3 | 38% |
| 70 | 68.3 | 136 | 180 | 1.5 | 32% |
| 70 + | 118.3 | 136 | 180 | 1.5 | 32% |
| 70 − | wets | 136 | 180 | 1.5 | 32% |
| 200 | 78.3 | 53 | 75 | 1.4 | 34% |
| 400 | 83.1 | 25 | 36 | 1.4 | 35% |
| 150 W | 63.7 | 45 | 118 | 0.76 | 52% |

In trials exploring the effect of spacer wettability, the surface of the metal mesh was modified in two ways. First, plasma-assisted chemical vapor deposition of a fluorocarbon film resulted in a surface with a water static contact angle of 110°. Second, electrochemical etching of the mesh in nitric acid resulted in a hydroxylated surface that had a water static contact angle of 40°.

In trials exploring the effect of surface tension, sodium dodecyl sulfate (SDS), sourced from Sigma-Aldrich, was used to alter the interfacial tension of the fluid phase. Because surfactants tend to aggregate at the surface, it was assumed that addition of SDS did not affect the thermodynamic concentration of water absorbed in the cellulose fibers at any given pressure. By using concentrations of 0, 2.0, and 6.0 mM SDS, fluids with surface tensions of 72, 61, and 40 mN/m were achieved, respectively.

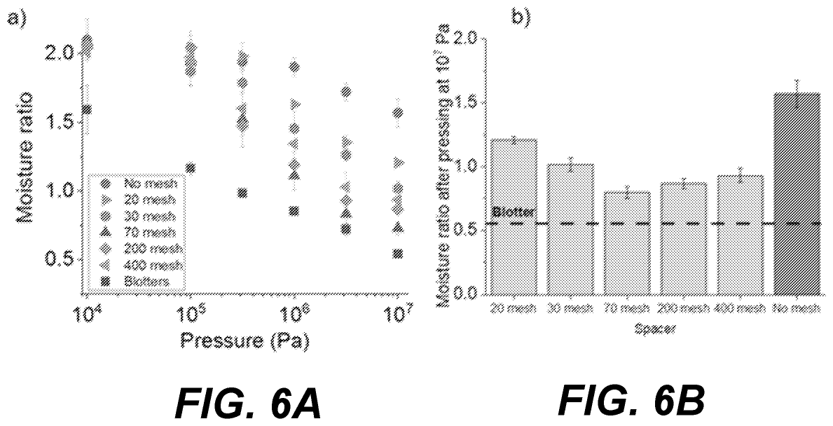

FIG. 6A shows what happens to paper pressed with different felt configurations as the applied stress is increased. As pressure is increased, more dewatering is accomplished. For low applied pressures, the extent of dewatering is minimal, because there is not enough force to push the water out of the paper into the fabric, which is slightly less hydrophilic. Once the pressure reaches a threshold of about 300,000 Pa, significantly more water is removed. This aligns with the moment that observable deformation of the web, which has a modulus on the order of 106 Pa, occurs. As applied stress is further increased, additional dewatering is obtained, although an asymptotic limit is approached. The diminishing return can be attributed to the components of free and bound water. At lower pressures, mechanical work primarily collapses the void volume of the paper web, driving out the relatively easy to remove free water that fills the large pores between fibers. At higher pressures, additional mechanical energy is devoted to removing bound water, water that is chemically interacting with the cellulose fibers. These intermolecular interactions determine the thermodynamic equilibrium of water content for the sheet at any given pressure. This can be expressed as a balance between the applied stress and the osmotic pressure of water absorbed in the fibers.

The equilibrium moisture value at any given pressure is captured by the bottom series in FIG. 6A (black squares). These data were created by pressing the sheet against a stack of paper blotters that is sufficiently thick (n=3) to irreversibly absorb water, instead of against a press felt. Blotters are highly absorbent sheets of paper that are used to remove water during manual manufacturing of paper sheets. Although it would be utterly impractical to dry paper commercially using three times the amount of paper produced, blotters provide a convenient way to eliminate reflux on the lab scale. Three blotters were used because preliminary experiments showed that addition of a fourth blotter showed no marginal improvement in dewatering, compared to using three blotters. This was done to ensure that dewatering was not limited by the capacity of the sink. Because the blotters are as hydrophilic as the paper being dewatered, reflux from a blotter stack to the sheet is presumed to be minimal. The cyan series in FIG. 6A illustrates what happens when a conventional press fabric is used to dewater the sheet. The higher moisture ratio for the sheet pressed against the commercial fabric compared to the sheet pressed against the blotters is attributed to rewet. At the highest stress applied, rewet results in more than double the moisture content after pressing—a significant problem, because all moisture after pressing must be removed through energy-intensive thermal drying.

FIG. 6A also compares the moisture ratio of pressed sheets with various commercial meshes sandwiched between the wetted fibrous and felt as de-wetting layers. At low applied pressures these de-wetting sheets can have a negligible impact on dewatering; when the pressure is too low to deform the paper sheet, the mesh—if anything—diminishes contact between the felt layer and wetted fibrous layer. In contrast, at higher pressures, when the wetted fibrous layer becomes significantly deformed and void volume in the paper is decreased, the enhanced dewatering capability in the presence of mesh spacers becomes apparent. Addition of a stiff, porous de-wetting sheet layer to the surface of a commercial press fabric results in less moisture in the pressed paper. For all the mesh structures tested, there was significant improvement in dewatering, but the details of the mesh design and dimensions clearly matter. For the best performing mesh spacer in FIGS. 6A and 6B (70 mesh), the dewatering efficiency approaches the theoretical limit defined by the blotter stack.

Clearly, the extent to which water is able to remain at the felt-web interface during pressing has a strong impact on the final moisture content of the dewatered paper. To provide more evidence for the conclusions that will ultimately be advanced, the effects of the spacer's surface wettability and of the liquid properties on dewatering are explored. Because the liquid bridge's behavior is the crux of the issue, it stands to reason that varying the liquid's physical parameters-including its interaction with the solid substrate-will elucidate the fundamental causes of enhanced dewatering.

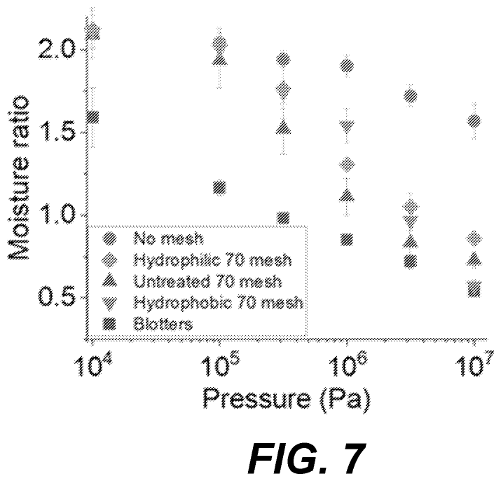

The present disclosure can investigate the effect of changing the wetting properties of the de-wetting sheet layer on dewatering. The chemistry of the stainless-steel mesh was altered with electrochemical etching in nitric acid to make it more wetting. The contact angle on the oxidized stainless-steel surface was about 40°, compared to native stainless steel which had a static contact angle of about 70°. Another mesh was coated with a fluorocarbon film, using the plasma reactor referenced previously. This brought the contact angle of water on the surface up to 110°. All three of these meshes, when used as spacers between the felt and the paper web resulted in better dewatering of the paper. Compared to pressing with the press fabric alone, insertion of a spacer with any wettability results in less water remaining in the sheet. The clustering of these data, especially compared to the no-spacer control, suggests, at a quick qualitative glance, that surface wettability is not the predominant driver of enhanced dewatering. In the interest of being more quantitative, the relative sizes of these effects can be calculated from the data in FIG. 7.

$$\frac{dMR}{d cos θ}$$

The cosine of the contact angle is representative of the surface wettability, so characterizes the effect of surface wettability on enhanced dewatering. From the data in FIG. 7,

$$\frac{dMR}{d cos θ} = - 0.1$$

at an applied pressure of 10 MPa. That means, changing the surface from neutrally wettable (contact angle=90°) to perfectly non-wetting would result in a 10% drier sheet. On the other hand, changing the surface from neutrally wettable to perfectly hydrophilic would result in a 10% wetter sheet. The magnitude of this effect can be compared to the difference in sheet moisture observed with having a spacer at all. Removal of the untreated 70 mesh spacer results in a 120% wetter sheet: more than twice as much water remains in the paper after pressing. Considering this fact, the data in FIG. 7 suggest that the mechanical, rather than chemical, properties of the spacer are the most relevant. The effect size differs by about an order of magnitude. Combined with the data from FIG. 6B—where large differences in dewatering enhancement were seen with spacers of varying geometries—a picture is emerging that mechanics are fundamentally driving this process. Thus, stiffness and geometric parameters (e.g., pore shape and size) of the spacers are key.

Although the effect of de-wetting sheet layer surface wettability is relatively minor, it is still statistically significant. Therefore, the effect of wettability, while certainly not the main cause, cannot be entirely ignored. As was quantified in the previous paragraph, making the de-wetting sheet more hydrophobic can reduce the residual water of the wetted fibrous layer—at greater pressures. At intermediate pressures, a more hydrophobic de-wetting sheet can result in worse dewatering, compared to more wettable de-wetting sheets. Reasoning about why this happens can best be conducted after the fundamental physics of the enhanced dewatering mechanism are properly considered. For now, it is worth appreciating that pressing with the hydrophobized spacer at the highest pressure results in near theoretically perfect dewatering. That data point falls on top of the blotter series, showing that this approach has the potential to entirely eliminate undesired reflux of water from the press fabric.

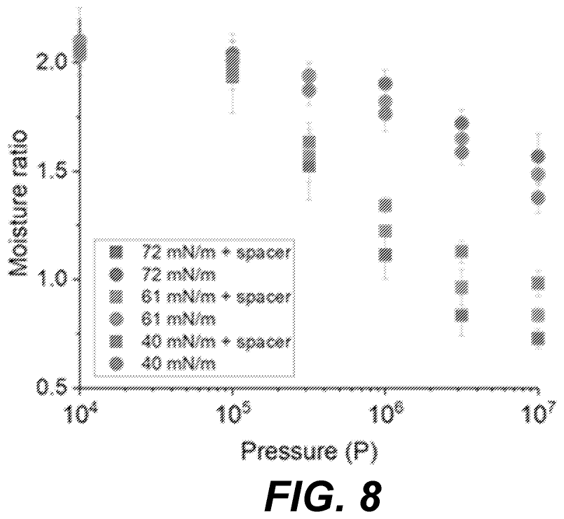

In addition to the surface chemistry, fluid properties like surface tension and viscosity could play a significant role in fluid transport, and the effect of those properties on dewatering was investigated next. To determine how liquid properties affect dewatering, the impact of surface tension was investigated in FIG. 8. Simply changing the surface tension of the liquid phase, however, is not so straightforward. Altering the chemistry of the liquid could change its molecular interactions with the cellulose fibers in the paper. This changes the equilibrium moisture content of the sheet, which establishes the theoretical limit of water removal. Additionally, independently varying the fluid's surface tension while holding all other properties constant is nearly impossible. For these reasons, addition of surfactant was chosen as the method to vary surface tension. Because of their tendency to aggregate at the liquid-air interface, surfactant molecules are less likely to interfere with the cellulose-water equilibrium. Furthermore, the dilute quantities of SDS needed to achieve changes in surface tension have a minimal impact on the liquid's density or viscosity. Surfactants are, however, not without their limitations. Their tendency to contaminate surfaces meant that extreme care had to be taken to conduct experiments with fresh fabrics, spacers, and paper for every trial.

Overall, changing the surface tension of the fluid has a relatively minor effect on dewatering, when the confounding effect of surface wettability (previously discussed) is accounted for. The effect of surface tension explored in FIG. 8 cannot be entirely disentangled from the effect of surface wettability seen in FIG. 7. There, it was shown that a more wettable surface resulted in marginally worse dewatering. Adding surfactant not only decreases the surface tension of the fluid, but it also increases wetting of the fluid on the de-wetting sheet surface. At least some of the increase in moisture content after pressing should be attributed to this effect. Explaining the opposite trend in the absence of the de-wetting sheet, i.e., lower surface tension results in improved dewatering, is somewhat subtler. Overall, decreasing the surface tension of the liquid closes the gap between dewatering with and without the de-wetting sheet. The lowest surface tension tested, however, was quite extreme for aqueous solutions. In a typical papermaking application, the surface tension of the process water, which is contaminated with some surfactants, falls in the range of 50-60 mN/m.

Adding a stiff and porous de-wetting sheet layer between two porous media can allow unobstructed, rapid transport during compression while preventing reflux upon decompression. The structure of the de-wetting sheet layer has a strong impact on the extent of enhanced dewatering. There was a tradeoff between having a large volume of fluid in the ruptured bridge and not having a spacer sufficiently thick to destabilize the liquid bridge effectively. Therefore, there is clearly a need to optimize the structure of the de-wetting sheet. This optimization can consider design space beyond what is simply available with commercial meshes. Future designs might involve creating a spacer with a smooth surface that interfaces with the paper web, while retaining the internal pore curvature needed to break liquid bridges.

Wetted fibrous handsheets were prepared at different basis weights from SBSK pulp, which was obtained as dry lap and resuspended in water. The handsheet protocol followed the standard TAPPI method up until pressing. Instead of pressing, the wetted fibrous layer webs were adjusted to a moisture ratio of 3 (25% solids) to simulate the couch solids on a paper machine. Solids content (also called consistency) is defined by the mass composition of water and fiber in the sheet.

The wetted fibrous layer web was then pressed against various felt configurations in a benchtop screw press. A force sensor allows the applied stress to be measured and controlled. The paper is pressed three times at a given pressure to simulate the sequence of nips on a paper making machine machine, to reduce variation introduced from control of the initial moisture ratio, and to show the limits of enhanced dewatering. Following pressing, the moisture content of the paper was determined by comparing the weight to that after oven-drying at 105° C. for 8 hrs.

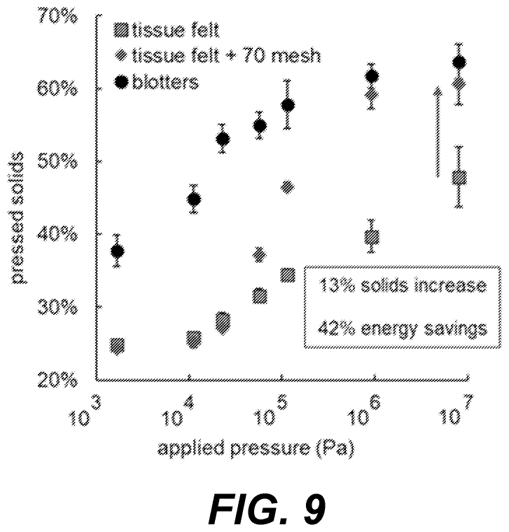

The impact of sandwiching a mechanically stiff de-wetting sheet layer between the press felt and wetted fibrous layer is illustrated in FIG. 9. In this case, a commercially available #70 stainless steel mesh was used as the stiff de-wetting sheet layer (the diamond series). The square series, which represents pressing with a commercial tissue felt, serves as the base case. The circle series, in which the paper is pressed with a thick stack of blotters, shows the upper limit of solids that can be realized at a given pressure in the absence of rewet. At low pressures, no mechanical dewatering is done; the blotters result in increased solids content because of the strong capillary forces exerted. As pressure is increased, more water is expelled from the web, resulting in higher press solids. At pressures relevant to industrial conditions (7 MPa) the web is significantly deformed, resulting in dewatering. The presence of a stiff de-wetting sheet layer enhances the dewatering potential of the press felt, as seen in the transition of the red series from the blue series to the black series. Pressing has shifted to a scenario where limited rewet occurs. An improvement of 13% solids from 48% to 61% corresponds to a 40% reduction in the residual moisture content of the pressed paper sheet. That translates to a 42% reduction in the energy load of subsequent drying operations, assuming the sheet is dried to 95% solids.

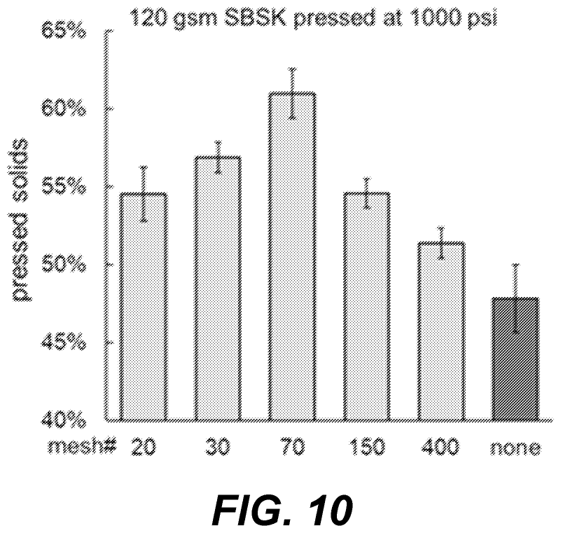

The dimensions of the de-wetting sheet layer have a significant effect on the stability of liquid channels between the felt and wetted fibrous layer. The pressed solids obtained with different commercially available meshes between the felt and paper are shown in FIG. 10. The solids appear to go through a maximum as the mesh size is changed; this suggests a certain tradeoff between various contributions. If the mesh number is too low (thick wires and large openings), the pressure applied to the sheet will not be uniform. Also, there is a greater volume of fluid within the liquid bridges (i.e., mesh openings). When these bridges are disrupted, more fluid can return to the sheet. On the other hand, high mesh numbers have small mesh openings that are similar in size to the filament and pore sizes already present in the felt. If the gap is too small, the liquid bridges are less likely to break, and the mesh-added felt system begins to resemble the felt alone. The optimum mesh size depends on the basis weight of the wetted fibrous layer, since deformation of the wetted fibrous web into the de-wetting sheet pores affects the gap height and, thus, liquid breakup.

For reasons of safety and wear, metal structures would be difficult to implement in a paper machine press nip. Metal materials, however, should not be necessary to achieve the desired liquid bridge breakup. Provided that the spacer layer is sufficiently stiff to resist significant deformation under nip loads, the approach should work well. Given that stress applied in the nip is around 10 MPa, any material that has a stiffness (i.e., elastic modulus) of at least 1 GPa will likely work as an example construction material for the de-watering sheet layer, if combined with a geometry that also enables the pore structure to remain open in the compressed state. Fortunately, there are many candidate materials that satisfy this criterion. Among them, nylon meshes are a natural choice as nylon is already used in press fabrics.

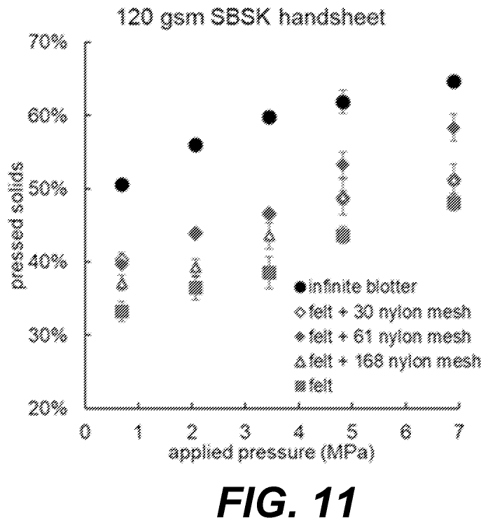

FIG. 11 shows the enhanced dewatering performance that nylon meshes add to a commercially available felt. Similar to the effect demonstrated with metal meshes, less water remained in the sheet after pressing when the de-wetting sheet layer is included. Once more, the dimensional parameters of the de-wetting sheet layer have a significant impact on the mitigation of rewet. Compared to pressing with the felt alone, each of the mesh-added felts showed at least some improvement in press solids. The greatest improvement was seen with the medium-sized mesh, implying that there is an opportunity to optimize the design of the de-wetting sheet layer beyond the commercially available meshes. As in FIG. 9, the gap between the blue and red series highlights the progress already made in developing this technology. The gap between the red and black series corresponds to the opportunity to further optimize this process. Although less improvement was seen with the nylon meshes compared to metal meshes, this is more indicative of only testing three structures, which is less likely to capture the optimum value.

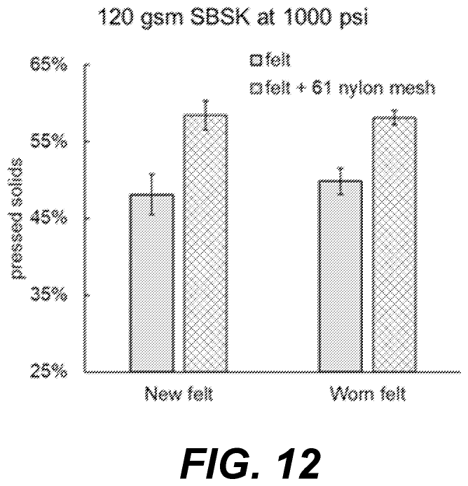

Because the technology works by disrupting the fluid phase, improved dewatering should be observed regardless of what felt is used, or in what condition the felt may be. FIG. 12 shows results obtained from pressing a 120 gsm SBSK handsheet at 1000 psi with new and used felts. Addition of a de-wetting sheet layer (e.g., a mesh) improved dewatering in both cases. The used felt appears to have marginally better dewatering ability, compared to the new felt. However, this is only because the new felt has not been sufficiently well conditioned. Overall, it is encouraging to see that the technology has high potential to work over the lifetime of the felt.

Enhanced dewatering can be realized by severing the liquid channels that would otherwise span the interface between the felt layer and the wetted fibrous layer. One mechanical way of accomplishing this is to introduce a stiff, porous de-wetting sheet layer between the felt layer and wetted fibrous web. Doing so effectively changes the boundary conditions of the interface while it is in the nip. Because the mechanism works by disrupting the fluid phase, it should only be indirectly influenced by other parameters in the system like nip load, pulp furnish, or press fabric. This means that application is likely to be wide-ranging, although some of the design optimization will depend on paper grade. While there is additional work to be done, initial results of this approach are promising. Improved dewatering observed on the lab-scale, coupled with a preliminary economic analysis, shows that structures that destabilize liquid channels at the interface have enormous potential in paper manufacture.

While the present disclosure has been described in connection with a plurality of exemplary aspects, as illustrated in the various figures and discussed above, it is understood that other similar aspects can be used, or modifications and additions can be made to the described aspects for performing the same function of the present disclosure without deviating therefrom. For example, in various aspects of the disclosure, methods and compositions were described according to aspects of the presently disclosed subject matter. However, other equivalent methods or composition to these described aspects are also contemplated by the teachings herein. Therefore, the present disclosure should not be limited to any single aspect, but rather construed in breadth and scope in accordance with the appended claims.

What is claimed is:

1. A process for de-wetting, the process comprising:
compressing a de-wetting sheet layer between a wetted fibrous layer and a felt layer, the de-wetting sheet layer comprising a plurality of pores, and the de-wetting sheet layer having a compressed state in which (i) liquid is allowed to flow therethrough and (ii) in which a thickness and/or a stiffness of the de-wetting sheet layer is sufficient to preserve a void volume between the wetted fibrous layer and the felt layer; and
decompressing the de-wetting sheet layer, the wetted fibrous layer, and the felt layer, the de-wetting sheet layer having a decompressed state in which liquid is prevented from flowing therethrough,
wherein the liquid is transferred from the wetted fibrous layer to the felt layer through the de-wetting sheet layer when the de-wetting sheet layer is in the compressed state.

2. The process of claim 1, wherein, in the decompressed state, liquid is prevented from flowing through the de-wetting sheet layer by severing a liquid film in the de-wetting sheet layer.

3. The process of claim 1, wherein the wetted fibrous layer and the felt layer comprise hydrophilic material and the de-wetting sheet layer comprises hydrophobic material.

4. The process of claim 1, wherein the de-wetting sheet layer comprises a polymer.

5. The process of claim 1, wherein the de-wetting sheet layer comprises a surface layer having a functional surface modification.

6. The process of claim 1, wherein the compression step maintains the de-wetting sheet layer in the compressed state for a time period from approximately 1 millisecond to approximately 15 seconds.

7. The process of claim 1, wherein the thickness of the de-wetting sheet layer is sufficient to prevent rewetting of liquid transferring from the felt layer to the wetted fibrous layer when the de-wetting sheet layer is in the decompressed state.

8. The process of claim 1, wherein the de-wetting sheet layer has a thickness from approximately 50 μm to approximately 500 μm.

9. The process of claim 1, wherein the plurality of pores each have a pore size from approximately 50 μm to approximately 500 μ.

10. The process of claim 1, wherein the plurality of pores have a total volume that decreases by 10% or less when the de-wetting sheet layer is compressed at a pressure of approximately 10 MPa or less.

11. The process of claim 10, wherein the total volume of the plurality of pores decreases by 50% or less when the de-wetting sheet layer is compressed at a pressure of approximately 10 MPa or less.

12. The process of claim 11, wherein the total volume of the plurality of pores decreases by 75% or less when the de-wetting sheet layer is compressed at a pressure of approximately 10 MPa or less.

13. The process of claim 1, wherein the plurality of pores have a first total volume in the compressed state and a second total volume in the decompressed state, the first total volume and the second total volume being approximately equivalent.

14. The process of claim 13, wherein the plurality of pores have a third total volume when compressed at a pressure of approximately 10 MPa, the third total volume being approximately equal to the first total volume and the second total volume.

15. A de-wetting sheet comprising:
a base layer comprising a plurality of pores;
wherein the de-wetting sheet has (i) a compressed state in which liquid is allowed to flow through the plurality of pores and the base layer has a thickness and/or a stiffness sufficient to preserve a void volume of the plurality of pores, and (ii) a decompressed state in which liquid is prevented from flowing through the plurality of pores.

16. The de-wetting sheet of claim 15, wherein, in the decompressed state, liquid is prevented from flowing through the de-wetting sheet layer by severing a liquid film in the de-wetting sheet layer.

17. The de-wetting sheet of claim 15, wherein the de-wetting sheet layer comprises a hydrophobic material.

18. The de-wetting sheet of claim 15, wherein the base layer comprises a polymer.

19. The de-wetting sheet of claim 15, further comprising a surface layer having a functional surface modification.

20. The de-wetting sheet of claim 15, wherein the de-wetting sheet layer is maintained in in the compressed state for a time period from approximately 1 millisecond to approximately 15 seconds.

21. The de-wetting sheet of claim 15, wherein the de-wetting sheet is positioned between a felt layer and a wetted fibrous layer.

22. The de-wetting sheet of claim 21, wherein the thickness of the de-wetting sheet layer is sufficient to prevent rewetting of liquid transferring from the felt layer to the wetted fibrous layer when the de-wetting sheet layer is in the decompressed state.

23. The de-wetting sheet of claim 15, wherein the de-wetting sheet layer has a thickness from approximately 50 μm to approximately 500 μm.

24. The de-wetting sheet of claim 15, wherein the plurality of pores each have a pore size from approximately 50 μm to approximately 500 μ.

25. The de-wetting sheet of claim 15, wherein the plurality of pores have a total volume that decreases by 10% or less when the de-wetting sheet layer is compressed at a pressure of approximately 10 MPa or less.

26. The process of claim 25, wherein the total volume of the plurality of pores decreases by 50% or less when the de-wetting sheet layer is compressed at a pressure of approximately 10 MPa or less.

27. The process of claim 26, wherein the total volume of the plurality of pores decreases by 75% or less when the de-wetting sheet layer is compressed at a pressure of approximately 10 MPa or less.

28. The process of claim 15, wherein the plurality of pores have a first total volume in the compressed state and a second total volume in the decompressed state, the first total volume and the second total volume being approximately equivalent.

29. The process of claim 28, wherein the plurality of pores have a third total volume when compressed at a pressure of approximately 10 MPa, the third total volume being approximately equal to the first total volume and the second total volume.

30. A de-wetting sheet comprising:
a felt layer; and
a base layer disposed on the felt layer, the base layer comprising a plurality of pores;
wherein the de-wetting sheet has (i) a compressed state in which liquid is allowed to flow through the plurality of pores and the base layer has a thickness and/or a stiffness sufficient to preserve a void volume of the plurality of pores, and (ii) a decompressed state in which liquid is prevented from flowing through the plurality of pores.

31. The de-wetting sheet of claim 30, wherein, in the decompressed state, liquid is prevented from flowing through the base layer by severing a liquid film in the de-wetting sheet layer.

32. The de-wetting sheet of claim 30, wherein the base layer comprises a hydrophobic material.

33. The de-wetting sheet of claim 30, wherein the base layer comprises a polymer.

34. The de-wetting sheet of claim 30, further comprising a surface layer disposed on the base layer, the surface layer having a functional surface modification.

35. The de-wetting sheet of claim 30, wherein the de-wetting sheet layer is maintained in in the compressed state for a time period from approximately 1 millisecond to approximately 15 seconds.

36. The de-wetting sheet of claim 30, wherein the de-wetting sheet is contacted with a wetted fibrous layer.

37. The de-wetting sheet of claim 36, wherein the thickness of the de-wetting sheet layer is sufficient to prevent rewetting of liquid transferring from the felt layer to the wetted fibrous layer when the de-wetting sheet layer is in the decompressed state.

38. The de-wetting sheet of claim 30, wherein the de-wetting sheet layer has a thickness from approximately 50 μm to approximately 500 μm.

39. The de-wetting sheet of claim 30, wherein the plurality of pores each have a pore size from approximately 50 μm to approximately 500 μ.

40. The de-wetting sheet of claim 30, wherein the plurality of pores have a total volume that decreases by 10% or less when the de-wetting sheet layer is compressed at a pressure of approximately 10 MPa or less.

41. The process of claim 40, wherein the total volume of the plurality of pores decreases by 50% or less when the de-wetting sheet layer is compressed at a pressure of approximately 10 MPa or less.

42. The process of claim 41, wherein the total volume of the plurality of pores decreases by 75% or less when the de-wetting sheet layer is compressed at a pressure of approximately 10 MPa or less.

43. The process of claim 30, wherein the plurality of pores have a first total volume in the compressed state and a second total volume in the decompressed state, the first total volume and the second total volume being approximately equivalent.

44. The process of claim 43, wherein the plurality of pores have a third total volume when compressed at a pressure of approximately 10 MPa, the third total volume being approximately equal to the first total volume and the second total volume.
